(19) United States
(12) Patent Application Publication
(10) Pub. No.: US 2014/0299249 A1
(43) Pub. Date: Oct. 9, 2014

(54) TIRE PROVIDED WITH AN OUTER SIDEWALL COMPRISING A MIXTURE OF A DIENE ELASTOMER AND A THERMOPLASTIC ELASTOMER

(71) Applicants: Emmanuel Custodero, Clermont-Ferrand (FR); Marc Greiveldinger, Clermont-Ferrand (FR); Cyrille Guery, Clermont-Ferrand (FR)

(72) Inventors: Emmanuel Custodero, Clermont-Ferrand (FR); Marc Greiveldinger, Clermont-Ferrand (FR); Cyrille Guery, Clermont-Ferrand (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/364,907

(22) PCT Filed: Dec. 5, 2012
(86) PCT No.: PCT/EP2012/074526

§ 371 Date: Jun. 12, 2014

(30) Foreign Application Priority Data
Dec. 16, 2011 (FR) 1161770

(51) Int. Cl. B60C 1/00

(52) U.S. Cl. CPC B60C 1/0025
USPC 152/525

(57) ABSTRACT

A tire includes an external sidewall, having improved airtightness. The external sidewall includes at least one rubber composition comprising at least one or more diene elastomers at a total content of 1 to 99 phr, one or more thermoplastic elastomers having a polyisobutylene block at a total content of 1 to 99 phr, optionally a reinforcing filler at a content of 0 to 120 phr, and a crosslinking system.

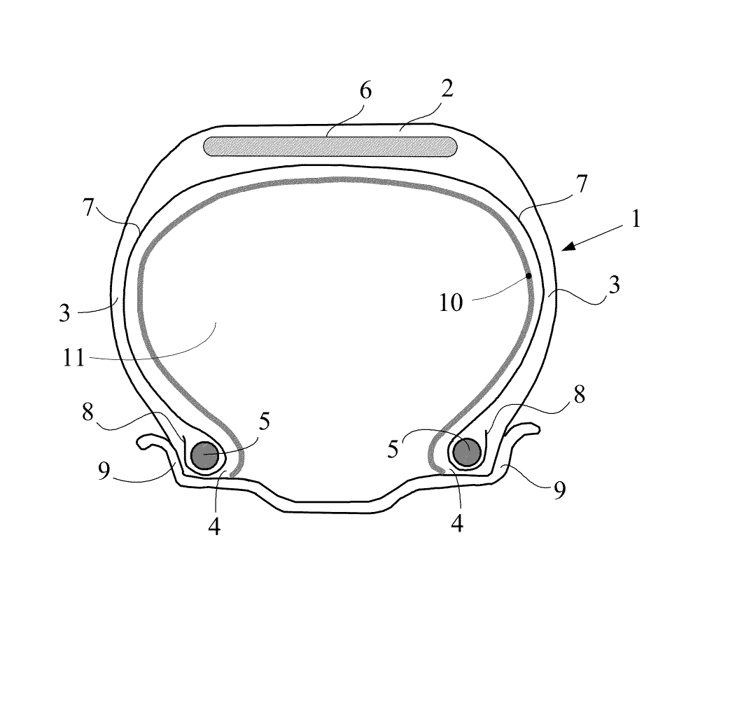

The present invention relates to tyres and more particularly to tyre external sidewalls, that is to say, by definition, to the elastomer layers located radially outside the tyre, which are in contact with the ambient air.

This is because it is possible to define, within the tyre, three types of regions:
The radially exterior region in contact with the ambient air, this region being essentially composed of the tread and of the external sidewall of the tyre. An external sidewall is an elastomer layer positioned outside the carcass reinforcement with respect to the internal cavity of the the tyre, between the crown and the bead, so as to completely or partially cover the region of the carcass reinforcement extending from the crown to the bead.
The radially interior region in contact with the inflation gas, this region generally being composed of the layer airtight to the inflation gases, sometimes known as inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

In a conventional tyre of the tubeless type, the radially internal face comprises an airtight layer (or more generally a layer airtight to any inflation gas) which makes it possible to inflate the tyre and to keep it under pressure. Its airtightness properties allow it to guarantee a relatively low level of pressure loss, making it possible to keep the tyre inflated in a normal operating state for a sufficient period of time, normally of several weeks or several months. Another role of this layer is to protect the carcass reinforcement and more generally the remainder of the tyre from the risk of oxidation due to the diffusion of air originating from the space interior to the tyre. This layer is known as “airtight layer” and it covers the entire internal wall of the tyre, extending from one sidewall to the other, at least as far as the level of the rim flange when the tyre is in the fitted position. It defines the radially internal face of the said tyre and has an airtightness coefficient such that the layer can be described as airtight with respect to the other layers of the tyre. Normally, this airtight layer is at least three times less permeable, that is to say at least three times more impermeable, than the external sidewalls.

The document WO 2008/145277 of the Applicant Companies provides a pneumatic object provided with a layer airtight to the inflation gases, in which the airtight layer comprises an elastomer composition comprising at least one copolymeric thermoplastic elastomer having polystyrene and polyisobutylene blocks and a polybutene oil.

Thus, this role of airtight layer or airtight inner liner is today fulfilled by compositions based on butyl rubber (copolymer of isobutylene and isoprene), which have been recognized for a very long time for their excellent airtightness properties, or based on copolymeric thermoplastic elastomer having polystyrene and polyisobutylene blocks.

It is known that the performances of the tyres are optimum for a defined inflation pressure. This inflation pressure has to be regularly checked by the users in order to allow them to obtain the best performances from their tyres. It is therefore desirable to further improve the overall airtightness of the tyres in order to improve the stability in performance of the tyres over time and to free the users from the need to regularly check the inflation pressure of their tyres.

A solution introduced by the Applicant Companies, which makes it possible to obtain tyres which exhibit an improved airtightness, consists in using novel external sidewall compositions having improved airtightness while otherwise retaining the expected level of their normal properties.

As illustrated by numerous documents, among which may be mentioned the documents EP 1 462 479 B1, EP 1 975 200 A1, EP 1 033 265 B1, EP 1 357 149 A2, EP 1 231 080 A1 and U.S. Pat. No. 4,824,900, the compositions conventionally used for sidewalls are based on natural rubber and on synthetic rubber, such as polybutadiene, and on carbon black.

Thus, a subject-matter of the invention currently proposed is a tyre provided with an external sidewall, having improved airtightness, the said external sidewall comprising at least one rubber composition comprising at least one or more diene elastomers, at a total content of 1 to 99 phr (parts by weight per hundred parts of elastomer), one or more thermoplastic elastomers having a polyisobutylene block, at a total content of 1 to 99 phr, optionally a reinforcing filler at a content of 0 to 120 phr and a crosslinking system.

This is because, surprisingly, this external sidewall has a better airtightness while retaining its other properties, in comparison with a conventional external sidewall composition.

Preferably again, the invention relates to a tyre as defined above, in which the content of thermoplastic elastomer having a polyisobutylene block is from 1 to 80 phr, preferably from 1 to 60 phr.

Preferentially, the invention relates to a tyre as defined above, in which the content of thermoplastic elastomer having a polyisobutylene block is from 5 to 60 phr, preferably from 5 to 50 phr.

Preferentially again, the invention relates to a tyre as defined above, in which the thermoplastic elastomer having a polyisobutylene block comprises, at at least one of the ends of the polyisobutylene block, a thermoplastic block for which the glass transition temperature is greater than or equal to 60° C.

More preferentially, the invention relates to a tyre as defined above, in which the thermoplastic block of the thermoplastic elastomer having a polyisobutylene block is composed of at least one polymerized monomer selected from the group consisting of styrene, methylstyrenes, para(tert-butyl)styrene, chlorostyrenes, bromostyrenes, fluorostyrenes, para-hydroxystyrene and the mixtures of these monomers.

More preferentially again, the invention relates to a tyre as defined above, in which the thermoplastic elastomer having a polyisobutylene block is selected from the group consisting of styrene/isobutylene diblock copolymers (“SIBs”), styrene/isobutylene/styrene triblock copolymers (“SIBSs”) and the mixtures of these copolymers.

Preferentially, the invention relates to a tyre as defined above, in which the thermoplastic elastomer having a polyisobutylene block is a styrene/isobutylene/styrene triblock copolymer (“SIBS”).

Preferentially again, the invention relates to a tyre as defined above, in which the thermoplastic block of the thermoplastic elastomer having a polyisobutylene block is composed of at least one polymerized monomer selected from the group consisting of ethylene, propylene, ethylene oxide, vinyl chloride, acenaphthylene, indene, 2-methylindene, 3-methylindene, 4-methylindene, dimethylindenes, 2-phenylindene, 3-phenylindene, 4-phenylindene, isoprene, esters of acrylic acid, crotonic acid, sorbic acid and methacrylic acid, acrylamide derivatives, methacrylamide derivatives, acrylonitrile derivatives, methacrylonitrile derivatives, methyl methacrylate, cellulose derivatives and the mixtures of these compounds.

More preferentially, the invention relates to a tyre as defined above, in which the diene elastomer or elastomers are selected from the group consisting of essentially unsaturated diene elastomers and the mixtures of these elastomers. Preferentially, the diene elastomer or elastomers are selected from the group consisting of the homopolymers obtained by polymerization of a conjugated diene monomer having from 4 to 12 carbon atoms, the copolymers obtained by copolymerization of one or more conjugated dienes with one another or with one or more vinylaromatic compounds having from 8 to 20 carbon atoms, and the mixtures of these. More preferentially still, the diene elastomer or elastomers are selected from the group consisting of polybutadienes, synthetic polyisoprenes, natural rubber, butadiene copolymers, isoprene copolymers (such as butadiene/styrene copolymers, isoprene/butadiene copolymers, isoprene/styrene copolymers and isoprene/butadiene/styrene copolymers) and the mixtures of these elastomers.

Preferably, the invention relates to a tyre as defined above, in which the content of reinforcing filler is from 0 to 90 phr, preferably from 5 to 80 phr.

Alternatively, preferably, the invention relates to a tyre as defined above, in which the content of reinforcing filler is from 0 to 70 phr, preferably from 5 to 70 phr.

Preferably again, the invention relates to a tyre as defined above, in which the reinforcing filler is carbon black and/or silica. Preferentially, the predominant reinforcing filler is carbon black.

Preferentially, the invention relates to a tyre as defined above, in which the content of diene elastomer is from 60 to 90 phr and the content of thermoplastic elastomer having a polyisobutylene block is from 10 to 40 phr.

Preferentially again, the invention relates to a tyre as defined above, in which the rubber composition of the said external sidewall does not comprise a polyisobutylene elastomer or comprises less than 15 phr, preferably less than 10 phr and more preferentially less than 5 phr thereof.

The invention relates more particularly to the tyres intended to equip motor vehicles of passenger vehicle type, SUVs (“Sport Utility Vehicles”), or two-wheel vehicles (in particular motorcycles), or aircraft, or also industrial vehicles chosen from vans, heavy-duty vehicles—that is to say, underground trains, buses, heavy road transport vehicles (lorries, tractors, trailers) or off-road vehicles, such as heavy agricultural vehicles or earthmoving equipment—, and other transportation or handling vehicles.

The invention and its advantages will be easily understood in the light of the description and implementational examples which follow, and also of the single figure relating to these examples, which diagrammatically represents, in radial cross section, a tyre in accordance with the invention.

### I. DETAILED DESCRIPTION OF THE INVENTION

In the present description, unless expressly indicated otherwise, all the percentages (%) shown are % by weight.

Furthermore, the term “phr” means, within the meaning of the present patent application, part by weight per hundred parts of elastomers, whether thermoplastic or non-thermoplastic elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### I-1. External Sidewall Elastomer Composition

The pneumatic object according to the invention has the essential characteristic of being provided with an external sidewall, the said external sidewall comprising at least one rubber composition comprising at least one or more diene elastomers, at a total content of 1 to 99 phr (parts by weight per hundred parts of elastomer), one or more thermoplastic elastomers having a polyisobutylene block, at a total content of 1 to 99 phr, optionally a reinforcing filler at a content of 0 to 120 phr and a crosslinking system.

### I-1-A. Essentially Unsaturated Diene Elastomer

As is normal, the terms “elastomer” and “rubber”, which are interchangeable, are used without distinction in the text.

A “diene” elastomer or rubber should be understood, in a known way, as meaning an (one or more is understood) elastomer resulting at least in part (i.e., a homopolymer or a copolymer) from diene monomers (monomers carrying two conjugated or non-conjugated carbon-carbon double bonds).

These diene elastomers can be classified into two categories: “essentially unsaturated” or “essentially saturated”.

“Essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

Thus it is that diene elastomers such as some butyl rubbers or copolymers of dienes and of α-olefins of EPDM type can be described as “essentially saturated” diene elastomers (low or very low content of units of diene origin, always less than 15%).

Given these definitions, essentially unsaturated diene elastomer capable of being used in the external sidewalls in accordance with the invention is understood more particularly to mean:

(a) any homopolymer obtained by polymerization of a conjugated diene monomer having from 4 to 12 carbon atoms;

(b) any copolymer obtained by copolymerization of one or more conjugated dienes with one another or with one or more vinylaromatic compounds having from 8 to 20 carbon atoms;

(c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene.

Although it applies to any type of essentially unsaturated diene elastomer, a person skilled in the art of the tyre will understand that, for use as tyre external sidewall, the present invention is preferably implemented with elastomers of the type (a) or (b) above.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention to may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The following are suitable: polybutadienes, in particular those having a content (mol %) of 1,2-units of between 4% and 80% or those having a content (mol %) of cis-1,4-units of greater than 80%, polyisoprenes, butadiene/styrene copolymers and in particular those having a glass transition temperature, Tg, (measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers and especially those having an isoprene content of between 5% and 90% by weight and a Tg of −40° C. to −80° C., or isoprene/styrene copolymers and especially those having a styrene content of between 5% and 50% by weight and a Tg of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene/styrene/isoprene copolymer having a Tg of between −20° C. and −70° C., are suitable in particular.

Finally, “isoprene elastomer” is understood to mean, in a known way, an isoprene homopolymer or copolymer, in other words a diene elastomer selected from the group consisting of natural rubber (NR), synthetic polyisoprenes (IRs), various isoprene copolymers and the mixtures of these elastomers. Mention will in particular be made, among isoprene copolymers, of isobutene/isoprene (IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, more preferably still of greater than 98%.

According to a preferred embodiment of the invention: the predominant elastomer of the composition in accordance with the invention is preferably selected from the group of essentially unsaturated diene elastomers consisting of polybutadienes (abbreviated to “BRs”), synthetic polyisoprenes (IRs), natural rubber (NR), butadiene copolymers, isoprene copolymers, butadiene/styrene copolymers (SBRs), isoprene/butadiene copolymers (BIRs), isoprene/styrene copolymers (SIRs) and isoprene/butadiene/styrene copolymers (SBIRs), and the mixtures of these elastomers.

The content of diene elastomer in the tyre external sidewall of use for the requirements of the invention is from 1 to 99 phr. Preferably, this content is from 20 to 99 phr, more preferably from 40 to 99 phr and more preferably from 40 to 95 phr. More preferably, this content is from 50 to 95 phr, in particular from more than 50 to 95 phr and more preferably still from 60 to 90 phr.

Preferably, in the composition of the external sidewall of the tyre of the invention, the diene elastomer is not mixed with a significant amount of polyisobutylene elastomer. The term “polyisobutylene elastomer” is understood to mean polyisobutylene or the random copolymers comprising more than 80% by weight of polyisobutylene (the polyisobutylene optionally being halogenated), such as rubbers of butyl type. Thus, preferably, the composition of the external sidewall of the tyre of the invention does not comprise a polyisobutylene elastomer, or else comprises less than 15 phr, preferably less than 10 phr and more preferably less than 5 phr thereof, in order not to harm the cohesive properties of this composition.

### I-1-B. Thermoplastic Elastomer Having a Polyisobutylene Block

Thermoplastic elastomers have a structure intermediate between thermoplastic polymers and elastomers. They are composed of rigid thermoplastic sequences connected by flexible elastomer sequences, for example polybutadiene, polyisoprene, poly(ethylene/butylene) or polyisobutylene. They are often triblock elastomers with two rigid segments connected by a flexible segment. The rigid and flexible segments can be positioned linearly, or in a star or branched configuration. Typically, each of these segments or blocks contains a minimum of more than 5, generally more than 10, base units (for example styrene units and isoprene units in the case of a styrene/isoprene/styrene block copolymer).

Preferably, the thermoplastic elastomer having a polyisobutylene block (hereinafter abbreviated to “TPEI”) according to a subject-matter of the invention comprises, at at least one of the ends of the polyisobutylene block, a thermoplastic block for which the glass transition temperature is greater than or equal to 60° C., preferably greater than or equal to 100° C. and more preferably greater than or equal to 130° C. Mention may be made, as examples of such thermoplastic blocks on these elastomers, of polystyrene (PS), polyvinyl chloride (PVC), polymethyl methacrylate (PMMA), polyethylene (PE), polypropylene (PP), polyethylene oxide (PEO), poly(acrylonitrile/butadiene/styrene) (ABS) or cellulose polymers (nitrocellulose, ethylcellulose, cellulose acetate, and the like).

The number-average molecular weight (denoted Mn) of the thermoplastic elastomer having a polyisobutylene block is preferably between 30 000 and 500 000 g/mol, more preferably between 40 000 and 400 000 g/mol. Below the minima indicated, there is a risk of an increase in the operating temperature affecting the mechanical properties, in particular the properties at break, with the consequence of a reduced performance “under hot conditions”. Furthermore, an excessively high weight Mn can be damaging to the flexibility of the external sidewall. Thus, it has been found that a value within a range from 50 000 to 300 000 g/mol was particularly well suited, in particular to use of the thermoplastic elastomer having a polyisobutylene block or TPEI in a composition for a tyre.

The number-average molecular weight (Mn) of the TPEI is determined, in a known manner, by steric exclusion chromatography (SEC). The sample is dissolved beforehand in tetrahydrofuran at a concentration of approximately 1 g/1 and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel trade names (HMW7, HMW6E and two HT6E), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

The polydispersity index PI (reminder: PI=Mw/Mn, with Mw the weight-average molecular weight) of the TPEI is preferably less than 3; more preferably, PI is less than 2 and more preferably still less than 1.5.

The polyisobutylene block of the TPEI is predominantly composed of the polymerized isobutylene monomer. Predominantly is understood to mean a content by weight of monomer, with respect to the total weight of the “polyisobutylene” block, which is the highest and preferably a content by weight of more than 50%, more preferably of more than 75% and for example of more than 85%. Preferably, the polyisobutylene block of the TPEI copolymer exhibits a number-average molecular weight (Mn) ranging from 25 000 g/mol to 350 000 g/mol, preferably from 35 000 g/mol to 250 000 g/mol, so as to confer, on the thermoplastic elastomer, good elastomeric properties and a mechanical strength which is sufficient and compatible with the external sidewall of a tyre application.

Preferably, the polyisobutylene block of the block copolymer additionally exhibits a glass transition temperature (“Tg”, measured according to ASTM D3418) of less than or equal to −20° C., more preferably of less than −40° C. A Tg value greater than these minima can diminish the performance of the external sidewall during use at very low temperature; for such a use, the Tg of the polyisobutylene block of the block copolymer is more preferably still less than −50° C.

The polyisobutylene block of the TPEI can also advantageously comprise a content of units resulting from one or more conjugated dienes inserted into the polymer chain preferably ranging up to 16% by weight, with respect to the weight of the polyisobutylene block. Above 16%, a fall may be observed in the resistance to thermal oxidation and to oxidation with ozone of the external sidewall comprising the thermoplastic elastomer having a polyisobutylene block used in a tyre.

The conjugated dienes which can be copolymerized with the isobutylene to form the polyisobutylene block are C₄-C₁₄ conjugated dienes. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture comprising isoprene.

The polyisobutylene block, according to an advantageous aspect of a subject-matter of the invention, can be halogenated and comprise halogen atoms in its chain. This halogenation makes it possible to increase the rate of curing of the composition comprising the thermoplastic elastomer having a polyisobutylene block according to the invention. This halogenation makes it possible to improve the compatibility of the external sidewall with the other adjacent constituent elements of a tyre. The halogenation is carried out using bromine or chlorine, preferably bromine, on the units resulting from conjugated dienes of the polymer chain of the polyisobutylene block. Only a portion of these units reacts with the halogen.

According to a first embodiment, the TPEI is chosen from styrene thermoplastic elastomers having a polyisobutylene block (“TPSI”).

The thermoplastic block is thus formed of at least one polymerized monomer based on styrene, unsubstituted and substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

Preferably, the thermoplastic elastomer TPSI is a polystyrene and polyisobutylene block copolymer.

Preferably, such a block copolymer is a styrene/isobutylene diblock copolymer (abbreviated to “SIB”).

Preferably again, such a block copolymer is a styrene/isobutylene/styrene triblock copolymer (abbreviated to “SIBS”).

According to a preferred embodiment of the invention, the content by weight of styrene (unsubstituted or substituted) in the styrene elastomer is between 5% and 50%.

Below the minimum indicated, there is a risk of the thermoplastic nature of the elastomer being substantially reduced while, above the recommended maximum, the elasticity of the external sidewall can be affected. For these reasons, the styrene content is more preferably between 10% and 40%, in particular between 15% and 35%.

TPSI elastomers are commercially available, for example sold, as regards SIBs and SIBSs, by Kaneka under the Sibstar name (e.g. Sibstar 103T, Sibstar 102T, Sibstar 073T or Sibstar 072T for the SIBSs and Sibstar 042D for the SIBs). They have, for example, been described, along with their synthesis, in the patent documents EP 731 112, U.S. Pat. No. 4,946,899 and U.S. Pat. No. 5,260,383. They were developed, first of all, for biomedical applications and then described in various applications specific to TPSI elastomers, as varied as medical equipment, parts for motor vehicles or for domestic electrical appliances, sheathing for electric wires, leaktightness parts or elastic parts (see, for example, EP 1 431 343, EP 1 561 783, EP 1 566 405 and WO 2005/103146). The document WO 2008/145277 of the Applicant Companies also describes the use of such TPSI elastomers in tyres, in compositions of layer airtight to the inflation gases.

According to a second embodiment, the TPEI elastomers can also comprise a thermoplastic block having a Tg greater than or equal to 60° C. and formed from polymerized monomers other than styrene monomers (abbreviated to “TPNSI”). Such monomers can be chosen from the following compounds and their mixtures:
ethylene and propylene;
vinyl chloride;
ethylene oxide;
acenaphthylene: a person skilled in the art may refer, for example, to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindene, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;
isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80;
esters of acrylic acid, crotonic acid, sorbic acid and methacrylic acid, acrylamide derivatives, methacrylamide derivatives, acrylonitrile derivatives, methacrylonitrile derivatives and their mixtures. Mention may more particularly be made of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyladamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-(tert-butyl)cyclohexyl methacrylate, tert-butyl methacrylate, 4-(tert-butyl)phenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-(sec-butyl)acrylamide, N-(tert-butyl)acrylamide, N,N-diisopropylacrylamide, N-(1-methylbutyl)acrylamide, N-methyl-N-phenylacrylamide, morpholylacrylamide, piperidylacrylamide, N-(tert-butyl)methacrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenylacrylate, acrylonitrile, methacrylonitrile and their mixtures.

According to another embodiment, the TPEI elastomers can also comprise a thermoplastic block having a Tg greater than or equal to 60° C. and formed from polymerized styrene and non-styrene monomers chosen from the monomers listed above. For example and preferably, the thermoplastic block can be composed of an acrylonitrile/butadiene/styrene (ABS) copolymer.

According to an alternative form, the polymerized monomer other than a styrene monomer can be copolymerized with at least one other monomer so as to form a thermoplastic block having a Tg varying from 60° C. to 200° C. According to this aspect, the molar fraction of polymerized monomer other than a styrene monomer, with respect to the total number of units of the thermoplastic block, has to be sufficient to achieve a Tg preferably varying from 60° C. to 180° C., more preferably from 80° C. to 150° C. and more preferably still from 100° C. to 130° C. Preferably again, the Tg of the thermoplastic block can vary from 80° C. to 150° C., or also preferably from 60° C. to 130° C., and more preferably still from 60° C. to 110° C. Advantageously, the molar fraction of this other comonomer can range from 0% to 90%, more preferably from 0% to 75% and more preferably still from 0% to 50%.

By way of illustration, this other monomer capable of copolymerizing with the polymerized monomer other than a styrene monomer can be chosen from diene monomers, more particularly conjugated diene monomers having from 4 to 14 carbon atoms, and monomers of vinylaromatic type having from 8 to 20 carbon atoms.

When the comonomer is a conjugated diene having from 4 to 14 carbon atoms, it advantageously represents a molar fraction, with respect to the total number of units of the thermoplastic block, ranging from 0% to 25%. Suitable as conjugated dienes which can be used in the thermoplastic blocks according to a subject-matter of the invention are those described above, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixtures.

When the comonomer is of vinylaromatic type, it advantageously represents a fraction of units, with regard to the total number of units of the thermoplastic block, from 0% to 90%, preferably ranging from 0% to 75% and more preferably still ranging from 0% to 50%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

Mention may be made, as illustrative but non-limiting examples, of mixtures of comonomers, which can be used for the preparation of thermoplastic blocks having a Tg greater than or equal to 100° C., composed of indene and of styrene derivatives, in particular para-methylstyrene or para(tert-butyl)styrene. A person skilled in the art may then refer to the documents J. E. Puskas, G. Kaszas, J. P. Kennedy and W. G. Hager, Journal of Polymer Science, Part A: Polymer Chemistry, 1992, 30, 41, or J. P. Kennedy, S. Midha and Y. Tsungae, Macromolecules (1993), 26, 429.

Preferentially, a TPNSI thermoplastic elastomer is a thermoplastic block/isobutylene block diblock copolymer. More preferably still, such a TPNSI thermoplastic elastomer is a thermoplastic block/isobutylene block/thermoplastic block triblock copolymer.

The TPEI elastomer (and preferably the TPSI elastomer as defined above) is preferably the only thermoplastic elastomer making up the external sidewall layer; it is optionally extended with an extending oil, such as, for example, a polybutene oil.

The amount of TPEI elastomer (and preferably of TPSI elastomer as defined above) in the tyre external sidewall of use for the requirements of the invention is from 1 to 99 phr. Preferably, this content is from 1 to 80 phr, more preferably from 1 to 60 phr and more preferably from 5 to 60 phr. More preferably, this content is from 5 to 50 phr, in particular from 5 to less than 50 phr and more preferably still from 10 to 40 phr.

### I-1-C. Reinforcing Filler

When a reinforcing filler is used, use may be made of any type of reinforcing filler known for its abilities to reinforce a rubber composition which can be used for the manufacture of tyres, for example an organic filler, such as carbon black, a reinforcing inorganic filler, such as silica, or also a blend of these two types of fillers, in particular a blend of carbon black and silica.

All the carbon blacks conventionally used in tyres (“tyre-grade” blacks) are suitable as carbon blacks. Mention will more particularly be made, for example, of the reinforcing carbon blacks of ASTM grade N326, N330, N339, N347 or N375, or else, depending on the applications targeted, the blacks of higher series (for example N550, N660, N683 or N772), indeed even N990.

In the case of the use of carbon blacks with an isoprene elastomer, the carbon blacks might, for example, be already incorporated in the isoprene elastomer in the form of a masterbatch (see, for example, Applications WO 97/36724 or WO 99/16600).

Mention may be made, as examples of organic fillers other than carbon blacks, of functionalized polyvinylaromatic organic fillers, such as described in Applications WO-A-2006/069792 and WO-A-2006/069793.

“Reinforcing inorganic filler” should be understood, in the present patent application, by definition, as meaning any inorganic or mineral filler, whatever its colour and its origin (natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g. Mention will be made, as highly dispersible precipitated silicas (HDSs), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

Use is made, in a known way, in order to couple the reinforcing inorganic filler to the diene elastomer, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Suitable in particular, without the definition below being limiting, are silane polysulphides referred to as “symmetrical”, corresponding to the following general formula (III):

(III) Z-A-Sₓ-A-Z, in which:

x is an integer from 2 to 8 (preferably from 2 to 5);

A is a divalent hydrocarbon radical (preferably C₁-C₁₈ alkylene groups or C₆-C₁₂ arylene groups, more particularly C₁-C₁₀; in particular C₁-C₄, alkylenes, in particular propylene);

Z corresponds to one of the formulae below:

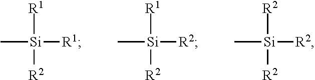

in which:

the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);

the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (III), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is made in particular, among these compounds, of bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl) tetrasulphide, such as described in Patent Application WO 02/083782 (or US 2004/132880).

Mention will in particular be made, as coupling agents other than an alkoxysilane polysulphide, of bifunctional POSs (polyorganosiloxanes) or else of hydroxysilane polysulphides (R²=OH in the above formula III), such as described in Patent Applications WO 02/30939 (or U.S. Pat. No. 6,774,255) and WO 02/31041 (or US 2004/051210), or else of silanes or POSs carrying azodicarbonyl functional groups, such as described, for example, in Patent Applications WO 2006/125532, WO 2006/125533 and WO 2006/125534.

Finally, a person skilled in the art will understand that, as filler equivalent to the reinforcing inorganic filler described in the present section, use might be made of a reinforcing filler of another nature, in particular organic nature, provided that this reinforcing filler is covered with an inorganic layer, such as silica, or else comprises functional sites, in particular hydroxyl sites, at its surface which require the use of a coupling agent in order to form the bond between the filler and the elastomer.

The content of total reinforcing filler (carbon black and/or reinforcing inorganic filler, such as silica) is within a range from 0 to 120 phr, more preferably from 0 to 90 phr, more particularly from 5 to 80 phr or from 0 to 70 phr and very preferably from 5 to 70 phr, the optimum being, of course, different according to the specific applications targeted and according to the type of carbon black used. It is clear that carbon blacks of very high ASTM grade, such as the carbon black N990, are less reinforcing than carbon blacks of 700 grade, and a fortiori 600 grade, and that it is necessary, for an identical reinforcement, to use greater contents of carbon black if carbon blacks of 900 grade are concerned than if blacks of 600 or 700 grade are concerned.

More preferably, the proportion of carbon black varies from 0 to 90 phr (preferably from 0 to 70 phr), in particular in the case of the use of carbon blacks of ASTM 600 or 700 grade, and more preferably still this proportion varies from 5 to 70 phr, particularly from 10 to 65 phr. Such amounts represent a content by volume varying from 0% to 30% in the composition, preferably from 1% to 25%.

The carbon black can advantageously constitute the only reinforcing filler or the predominant reinforcing filler (that is to say that for which the content is the greatest, for example at 50% of the total weight of the reinforcing filler or more in a mixture of two types of fillers). Of course, it is possible to use just one carbon black or a blend of several carbon blacks of different ASTM grades. The carbon black can also be used as a blend with other reinforcing fillers and in particular reinforcing inorganic fillers as described above, in particular silica. Preferably, the carbon black is the only reinforcing filler in the external sidewall composition.

When an inorganic filler (for example silica) is used in the composition, alone or as a blend with carbon black, its content is within a range from 0 to 120 phr (preferably from 0 to 110 phr), in particular also from 0 to 60 phr, and more preferably still this proportion varies from 0 to 30 phr, particularly from 5 to 20 phr.

### I-1-D. Plasticizers

The diene elastomer, the thermoplastic elastomer and the filler described above are sufficient by themselves alone for the functions of the external sidewalls of the pneumatic objects in which they are used to be fulfilled.

However, according to a preferred embodiment of the invention, the elastomer composition described above also comprises a plasticizing agent, the role of which is to facilitate the processing of the external sidewall, in particular its incorporation in the pneumatic object, by a lowering of the modulus and an increase in the tackifying power.

Use may be made of any type of plasticizer which can be a resin or an extending oil. The designation “resin” is reserved in the present patent application, by definition known to a person skilled in the art, for a compound which is solid at ambient temperature (23° C.), in contrast to a liquid plasticizing compound, such as an extending oil or plasticizing oil. At ambient temperature (23° C.), these oils, which are more or less viscous, are liquids (that is to say, as a reminder, substances which have the ability to eventually assume the shape of their container), in contrast in particular to resins or rubbers, which are by nature solids.

Hydrocarbon resins are polymers well known to a person skilled in the art, essentially based on carbon and hydrogen, which can be used in particular as plasticizing agents in polymer matrices. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). They are by definition miscible (i.e., compatible) at the contents used with the polymer compositions for which they are intended, so as to act as true diluents. Their Tg is preferably greater than 0° C., in particular greater than 20° C. (generally between 30° C. and 120° C.).

In a known way, these hydrocarbon resins can also be described as thermoplastic resins in the sense that they soften when heated and can thus be moulded. They can also be defined by a softening point, the temperature at which the product, for example in the powder form, sticks together. The softening point of a hydrocarbon resin is generally greater by approximately 50 to 60° C. than its Tg value.

Mention may be made, as examples of such hydrocarbon resins, of those selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

All the above resins are well known to a person skilled in the art and are commercially available, for example sold by DRT under the name Dercolyte as regards polylimonene resins, by Neville Chemical Company under the name Super Nevtac, by Kolon under the name Hikorez or by Exxon Mobil under the name Escorez as regards C₅ fraction/styrene resins or C₅ fraction/C₉ fraction resins, by Struktol under the name 40 MS or 40 NS (mixtures of aromatic and/or aliphatic resins), or also by Eastman under the name Eastotac, such as Eastotac H-142W, as regards hydrogenated aliphatic hydrocarbon resins.

Preferably, the extending oil is selected from the group consisting of polyolefinic oils (that is to say, resulting from the polymerization of monoolefinic or diolefinic olefins), paraffinic oils, naphthenic oils (of low or high viscosity), aromatic oils, mineral oils and the mixtures of these oils. For example, the extending oil can be a polybutene oil and in particular a polyisobutylene oil.

While it has been found that the addition of oil has admittedly been made at the price of a certain loss in airtightness, which can vary according to the type and the amount of oil used, this loss in airtightness can be largely corrected, in particular by addition of a platy filler.

The number-average molecular weight (Mn) of the extending oil is preferably between 200 and 25 000 g/mol, more preferably still between 300 and 10 000 g/mol. For excessively low Mn weights, there exists a risk of migration of the oil outside the composition, whereas excessively high weights can result in excessive stiffening of this composition. An Mn weight of between 350 and 4000 g/mol, in particular between 400 and 3000 g/mol, has proved to constitute an excellent compromise for the targeted applications, in particular for use in a tyre.

The number-average molecular weight (Mn) of the extending oil is determined by SEC, the sample being dissolved beforehand in tetrahydrofuran at a concentration of approximately 1 g/1; the solution is then filtered through a filter with a porosity of 0.45 μm before injection. The apparatus is the Waters Alliance chromatographic line. The elution solvent is tetrahydrofuran, the flow rate is 1 ml/min, the temperature of the system is 35° C. and the analytical time is 30 min. A set of two Waters columns with the Styragel HT6E name is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

A person skilled in the art will know, in the light of the description and implementational examples which follow, how to adjust the amount of plasticizer as a function of the TPEI elastomer used (as indicated above), of the properties of the external sidewall composition and of the specific conditions of use of the external sidewall, and in particular as a function of the pneumatic object in which it is intended to be used.

When it is used, it is preferable for the content of plasticizer to vary from 2 to 60 phr, more preferably from 3 to 50 phr. Below the minimum indicated, the presence of plasticizer is not perceptible. Above the maximum recommended, a risk exists of insufficient cohesion of the composition and of loss in airtightness which can be harmful according to the application under consideration.

### I-1-E. Platy Filler

The optional use of platy filler advantageously makes it possible to lower the coefficient of permeability (and thus to increase the airtightness) of the elastomer composition, without excessively increasing its modulus, which makes it possible to retain the ease of incorporation of the external sidewall in the pneumatic object.

“Platy” fillers are well known to a person skilled in the art. They have been used in particular in tyres in order to reduce the permeability of conventional airtight layers based on butyl rubber. They are generally used at relatively low contents, generally not exceeding 1 to 50 phr, or contents by volume which can vary in particular from 0.1% to 25% by volume of elastomer composition and preferably from 1% to 20% by volume.

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the mean thickness of these platy fillers, these means being calculated on a number basis. Aspect ratios reaching several tens, indeed even several hundreds, are frequent. Their mean length is preferably greater than 1 μm (that is to say that “micrometric” platy fillers are then involved), typically between several μm (for example 5 μm) and several hundred μm (for example 500 μm, indeed even 800 μm).

Preferably, the platy fillers used in accordance with the invention are selected from the group consisting of graphites, silicon-based platy mineral fillers and the mixtures of such fillers.

The term “graphite” is understood to mean, generally, an assembly of non-compact hexagonal sheets of carbon atoms: graphenes. Graphite, a hexagonal crystalline system, exhibits a stack of ABAB type, where the B plane is translated relative to the A plane.

Graphite cannot be regarded as a reinforcing filler within the meaning of the definition specified in section I-1-B; however, it can be regarded as a semi-reinforcing (or partially reinforcing) filler in so far as it makes possible an increase in the tensile modulus of a rubber composition in which it is incorporated.

Given these definitions, graphite capable of being used in the compositions in accordance with the invention is understood more particularly to mean:

(a) any natural graphite, associated with rocks affected by metamorphism, after the separation of the impurities accompanying the graphite veins and after milling;
(b) any thermally expandable natural graphite, i.e. in which one or more chemical compounds in the liquid state, for example an acid, is intercalated between its graphene planes;
(c) any expanded natural graphite, the latter being produced in two steps: intercalation of one or more chemical compounds in the liquid state, for example an acid, between the graphene planes of a natural graphite by chemical treatment and high-temperature expansion;
(d) any synthetic graphite obtained by graphitization of petroleum coke.

The compositions of the invention can comprise just one graphite or a mixture of several graphites; thus, it is possible to have a blend of natural graphite and/or of expanded graphite and/or of synthetic graphite.

The graphite as defined above can be provided morphologically in a lamellar or non-lamellar form and will in both cases be categorized as a platy filler within the meaning of the present invention.

It has been found, surprisingly, that graphites with either of these two types of morphology are suitable in the compositions in accordance with the invention; however, graphites exhibiting a lamellar form are preferentially suitable, all the more so when they are oriented so as to present their largest face perpendicular to the gas permeation stream.

When it is used, the graphite is present in the composition at contents ranging from 1 phr to 60 phr and preferably between 5 and 30 phr.

Suitable in particular among silicon-based platy mineral fillers are phyllosilicates and particularly those included in the group consisting of smectites, kaolin, talc, mica and vermiculite.

Also suitable for the invention among phyllosilicates are functionalized phyllosilicates and in particular organomodified phyllosilicates. According to a specific embodiment, the organic structure with which the inert filler is combined is a surfactant of formula: -M⁺R¹R²R³; where M represents a nitrogen, sulphur, phosphorus or pyridine atom and where R¹, R² and R³ represent a hydrogen atom, an alkyl group, an aryl group or an allyl group, R¹, R² and R³ being identical or different.

In particular, organomodified montmorillonites are suitable for the invention. Thus, montmorillonites modified with a surfactant, such as a dihydrogenated dioctadecyldimethyl quaternary ammonium salt. Such an organomodified montmorillonite is commercially available, in particular from Southern Clay Products under the trade name: Cloisite 6A and 20A.

Other surfactants based on quaternary ammonium salts can also be used to modify phyllosilicates, such as are described in Patent Application WO06/047509.

Mention may be made, as examples of micas, of the micas sold by CMMP (Mica-MU®, Mica-Soft®, Briomica®, for example), those sold by Yamaguchi (A51S, A41S, SYA-21R, SYA-21RS, A21S, SYA-41R), vermiculites (in particular the Shawatec® vermiculite sold by CMMP or the Microlite® vermiculite sold by W. R. Grace), or modified or treated micas (for example, the Iriodin® range sold by Merck). Mention may be made, as examples of graphites, of the graphites sold by Timcal (Timrex® range). Mention may be made, as examples of talcs, of the talcs sold by Luzenac.

The abovementioned inert fillers, other than graphite, are in fact particularly advantageous as they make it possible to improve the impermeability of the compositions in which they are dispersed with an appropriate content. For example, when they are used, their content can vary from 1 phr to 80 phr and preferably from 3 to 40 phr.

The introduction of the platy fillers into the elastomer composition can be carried out according to various known processes, for example by mixing in solution, by mixing in bulk in an internal mixer, or also by mixing by extrusion.

### I-1-F. Crosslinking System

The crosslinking system can be a vulcanization system; it is preferably based on sulphur (or sulphur donor) and on a primary vulcanization accelerator. Additional to this vulcanization system are optionally various known secondary vulcanization accelerators or vulcanization activators (preferably for 0.5 to 5.0 phr each), such as zinc oxide, stearic acid, guanidine derivatives (in particular diphenylguanidine), and the like. The sulphur or a sulphur donor is used at a preferred content of between 0.5 and 10 phr, more preferably between 0.5 and 5.0 phr, for example between 0.5 and 3.0 phr, when the invention is applied to a tyre external sidewall. Mention may be made, among sulphur donors, for example, of alkylphenol disulphides (APDSs), such as, for example, para-tert-butylphenol disulphide.

Use may be made, as (primary or secondary) accelerator, of any compound capable of acting as accelerator of the vulcanization of diene elastomers in the presence of sulphur, in particular accelerators of the thiazole type and their derivatives and accelerators of the thiuram and zinc dithiocarbamate types. These accelerators are more preferably selected from the group consisting of 2-mercaptobenzothiazyl disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-(tert-butyl)-2-benzothiazolesulphenamide (abbreviated to “TBBS”), N-(tert-butyl)-2-benzothiazolesulphenimide (abbreviated to “TBSI”), zinc dibenzyldithiocarbamate (abbreviated to “ZBEC”) and the mixtures of these compounds. Preferably, use is made of a primary accelerator of the sulphenamide type.

### I-1-G. Various Additives

The external sidewall composition described above can furthermore comprise the various additives normally present in the external sidewalls known to a person skilled in the art. Mention will be made, for example, of non-reinforcing or inert fillers other than the platy fillers described above, plasticizers other than the abovementioned extending oils, tackifying resins, protection agents, such as antioxidants or antiozonants, UV inhibitors, various processing aids or other stabilizing agents, or also promoters capable of favouring the adhesion to the remainder of the structure of the pneumatic object.

In addition to the elastomers (diene or TPEI) described above, the external sidewall composition might also comprise, always according to a minor fraction by weight with respect to the block elastomer, polymers other than elastomers, such as, for example, thermoplastic polymers.

### I-2. Preparation of the External Sidewall of the Invention

In order to prepare the external sidewall according to the invention, the elastomers are mixed with the other components of the external sidewall, i.e. the reinforcing filler, and also the crosslinking system and the optional other ingredients, such as the plasticizers. In order to obtain a good dispersion of the thermoplastic elastomer within the composition, the elastomer has to be heated to a sufficient temperature, for example 60 to 200° C., preferably 80 to 180° C., in order for the mixing temperature to reach the softening point of the thermoplastic blocks of the TPEI. Heating for a sufficiently long period of time, for example from 3 to 20 minutes, preferably from 5 to 15 minutes, makes it possible for the TPEI, softened by the high temperature, to be able to be homogeneously dispersed in the mixture, preferably in the form of domains not exceeding a few microns. It is possible to facilitate the operation by introducing the TPEI in a “fine powder” form or by pre-diluting it with a plasticizer. In the light of that which follows, a person skilled in the art can adjust the order of incorporation of the ingredients (all at once or in several successive stages), the mixing temperature and time, and, if need be, the content of plasticizer, as a function of the softening point of the thermoplastic elastomer chosen.

Thus, the invention also relates to a process for the manufacture of a pneumatic object as defined above, in which the rubber composition of the external sidewall is manufactured according to a process comprising at least one stage of mixing the elastomers of the composition and the reinforcing filler, at a temperature varying from 60 to 200° C. (preferably 80 to 180° C.), for 3 to 20 minutes (preferably 5 to 15 minutes).

The preferences described for the compositions of the external sidewalls of the tyres according to the invention apply mutatis mutandis to the process as described above.

According to a first embodiment, the following procedure is used for the tests: the diene elastomer or elastomers, the thermoplastic elastomer or elastomers having a polyisobutylene block, the reinforcing filler or fillers and the optional other ingredients, with the exception of the vulcanization system, are successively introduced into an internal mixer, approximately 70% (plus or minus 5%) filled and for which the initial vessel temperature is between 40° C. and 80° C. Thermomechanical working (non-productive phase) is then carried out in a stage which lasts in total approximately from 3 to 4 minutes, until a maximum “dropping” temperature of 150° C. is reached.

The mixture thus obtained is recovered and cooled and then sulphur and an accelerator are incorporated on an external mixer (homofinisher) at 30° C., everything being mixed (productive phase) for an appropriate time (for example between 5 and 12 min).

If this first embodiment is used, the choice will be made, for facilitated implementation, of a TPEI elastomer having a softening point (measured according to Standard ISO 4625, “Ring and Ball” method) of less than or equal to 150° C. If, for other reasons, the TPEI chosen has a softening point of greater than 130° C. or than 150° C., it will then be possible to incorporate a content of extending oil in the TPEI in order to make possible good processing of the mixture at a temperature of less than or equal to 130° C. or of less than or equal to 150° C. respectively. In these cases, a masterbatch will be prepared, for example, by mixing the TPEI and an extending oil (for example using a twin-screw extruder), which masterbatch can be used in the process described above. When a TPEI elastomer for which the softening point is less than or equal to 150° C. is used, it is preferable for the content of extending oil to vary from 2 to 15 phr, in particular from 2 to 10 phr. When a TPEI elastomer for which the softening point is greater than 150° C. is used, it is preferable for the total content of extending oil, that is to say the content of oil incorporated in the TPEI added to the content of oil optionally incorporated in the initial elastomeric mixture, to vary from 5 to 50 phr, more preferably from 10 to 40 phr, in particular from 15 to 30 phr.

According to another embodiment, all the components, including the vulcanization system, can be introduced successively into the internal mixer as described above. In this case, the mixing has to be carried out up to a “dropping” temperature of less than or equal to 130° C., preferably of less than or equal to 120° C. and in particular of less than or equal to 110° C.

If this second embodiment is used, the choice will be made, for a facilitated implementation, of a TPEI elastomer having a softening point (measured according to Standard ISO 4625, “Ring and Ball” method) of less than or equal to 130° C., preferably of less than 120° C. and in particular of less than 110° C. If, for other reasons, the TPEI chosen has a softening point of greater than 130° C., it will then be possible to incorporate a content of extending oil in the TPEI in order to make possible good processing of the mixture at a temperature of less than or equal to 130° C.; in this case, a masterbatch will be prepared, for example, by mixing the TPEI and an extending oil (for example using a twin-screw extruder), which masterbatch can be used in the process described above. When a TPEI elastomer for which the softening point is less than or equal to 130° C. is used, it is preferable for the content of extending oil to vary from 2 to 15 phr, in particular from 2 to 10 phr. When a TPEI elastomer for which the softening point is greater than 130° C. is used, it is preferable for the total content of extending oil, that is to say the content of oil incorporated in the TPEI added to the content of oil optionally incorporated in the initial elastomeric mixture, to vary from 5 to 50 phr, more preferably from 10 to 40 phr, in particular from 15 to 30 phr.

In some alternative embodiments, one or more of the elastomers (diene and/or thermoplastic) used in the composition can be introduced in the form of a masterbatch or premixed with some of the components of the composition.

The compositions thus obtained are subsequently calendered, either in the form of plaques (thickness from 2 to 3 mm) or thin sheets of rubber, for the measurement of their physical or mechanical properties, or extruded in the form of tyre external sidewalls.

### I-3. Use of the External Sidewall in a Tyre

The external sidewall described above is particularly well suited to use as finished or semi-finished product made of rubber, very particularly in a tyre for a motor vehicle, such as a vehicle of two-wheel, passenger vehicle or industrial type.

It will be easily understood that, according to the specific fields of application, the dimensions and the pressures involved, the embodiment of the invention can vary; the external sidewall then comprises several preferred embodiments.

### II. EXAMPLES OF THE IMPLEMENTATION OF THE INVENTION

The external sidewall described above can advantageously be used in tyres for all types of vehicles, in particular passenger vehicles or industrial vehicles, such as heavy-duty vehicles.

By way of example, the single appended figure represents very diagrammatically (without observing a specific scale) a radial section of a tyre in accordance with the invention.

This tyre 1 comprises a crown 2 reinforced by a crown reinforcement or belt 6, two external sidewalls 3 and two beads 4, each of these beads 4 being reinforced with a bead wire 5. The crown 2 is surmounted by a tread, not represented in this diagrammatic figure. A carcass reinforcement 7 is wound around the two bead wires 5 in each bead 4, the turn-up 8 of this reinforcement 7 being, for example, positioned towards the outside of the tyre 1, which is here represented fitted onto its wheel rim 9. The carcass reinforcement 7 is, in a way known per se, composed of at least one ply reinforced by “radial” cords, for example of textile or metal, that is to say that these cords are positioned virtually parallel to one another and extend from one bead to the other so as to form an angle of between 80° and 90° with the median circumferential plane (plane perpendicular to the axis of rotation of the tyre which is situated at mid-distance from the two beads 4 and passes through the middle of the crown reinforcement 6).

The internal wall of the tyre 1 comprises an airtight layer 10, for example with a thickness equal to approximately 0.9 mm, on the side of the internal cavity 11 of the tyre 1.

The tyre in accordance with the invention can use, for example for the composition of its external sidewall, as defined above, a composition comprising in particular a thermoplastic elastomer having an isobutylene block, such as the SIBS, Sibstar 102 T, sold by Kaneka.

The tyre provided with its external sidewall as described above is preferably produced before vulcanization (or curing). The vulcanization is subsequently carried out conventionally. The block elastomers withstand well the stresses related to the vulcanization stage.

An alternative manufacturing form which is advantageous, for a person skilled in the art of tyres, will consist, for example during a first stage, in depositing the airtight layer flat directly on a tyre-building drum, in the form of a skim of suitable thickness, before covering the latter with the remainder of the structure of the tyre, according to manufacturing techniques well known to a person skilled in the art.

### II-1. Tests

The properties of the elastomer compositions and of some of their constituents are characterized as indicated below:

II-1-a. Airtightness Tests

Use was made, for this analysis, of a rigid wall permeameter, placed in an oven (temperature at 60° C. in the present case), equipped with a relative pressure sensor (calibrated in the range from 0 to 6 bar) and connected to a tube equipped with an inflation valve. The permeameter can receive standard test specimens in the disc form (for example, with a diameter of 65 mm in the present case) and with a uniform thickness which can range up to 1.5 mm (0.5 mm in the present case). The pressure sensor is connected to a National Instruments data acquisition card (0-10 V analogue four-channel acquisition) which is connected to a computer carrying out continuous acquisition with a frequency of 0.5 Hz (1 point every two seconds). The permeability coefficient (K) is measured from the linear regression line giving the slope a of the loss in pressure through the tested test specimen as a function of the time, after stabilization of the system, that is to say the achievement of stable conditions under which the pressure decreases linearly as a function of the time. An arbitrary value of 100 is given for the airtightness of the control, a result greater than 100 indicating an increase in the airtightness and thus a decrease in the permeability.

II-1-B. Measurement of Breaking Stress Before and after Curing

Ultimate tensile tests were carried out before and after curing the mixtures on ASTM C test specimens, at ambient temperature. These tensile tests make it possible to determine the properties at break and in particular the nominal breaking stress and also the strain at break. The results given in the examples which follow correspond to the nominal breaking stress and are expressed in base 100, that is to say that an arbitrary value of 100 is given for the breaking stress of the control, a result greater than 100 indicating an increase in the breaking stress and vice versa.

### II-2. Trials

Conventional external sidewall compositions, comprising ordinary elastomers, reinforcing fillers and ordinary additives, were prepared as controls (A1).

### II-2-A. Example A

The compositions prepared comprise the same contents of all the ingredients, except for the elastomers. The control composition A1 does not comprise TPEI while, in the composition A2 in accordance with the invention, the content of diene elastomers is lowered in order to add a portion of TPEI to the composition. The other control composition A3 corresponds to the composition according to the invention in which the TPEI is replaced by an essentially saturated diene elastomer of butyl type.

Airtightness tests and breaking stress measurement tests as described above were carried out on these compositions. All the compositions and also the airtightness and breaking stress performances in base 100 are presented in Table 1. The composition A1 is taken as reference and the contents are all expressed in phr.

TABLE 1

| Composition No.: | A1 | A2 | A3 |
|---|---|---|---|
| NR (1) | 35 | 24 | 24 |
| BR (2) | 65 | 46 | 46 |
| SIBS (3) | 0 | 30 | 0 |
| IIR (4) | 0 | 0 | 30 |
| Carbon black (5) | 61 | 61 | 61 |
| Plasticizer (6) | 27 | 27 | 27 |
| Antioxidant (7) | 4 | 4 | 4 |
| Stearic acid | 1 | 1 | 1 |
| ZnO | 3 | 3 | 3 |
| Sulphur | 2 | 2 | 2 |
| Accelerator (8) | 1 | 1 | 1 |
| Relative airtightness | 100 | 140 | 115 |
| Cured breaking stress performance | 100 | 97 | 95 |
| Raw breaking stress performance | 100 | 96 | 31 |

(1) NR Natural rubber
(2) BR with 0.5% of 1,2- units; 1.2% of trans units; 98.3% of cis-1,4- units (Tg = −106° C.)
(3) SIBS, Sibstar 102 T, sold by Kaneka
(4) IIR, Butyl 365, sold by Exxon
(5) ASTM grade N683, sold by Cabot
(6) MES oil, Catenex SNR, sold by Shell
(7) N-(1,3-Dimethylbutyl)-N′-phenyl-p-phenylenediamine, 6-PPD from Flexsys
(8) N-Cyclohexyl-2-benzothiazolesulphenamide, Santocure CBS from Flexsys

The results presented in Table 1 show a very significant enhancement in the airtightness performance of the composition A2 in comparison with the performance of the composition A1. The composition A3 exhibits a distinctly weaker advantage in comparison with the composition A1. In terms of cured breaking stress performance, the compositions A1, A2 and A3 are fairly similar while, in terms of raw breaking stress performance, it is apparent that the composition A2 of the external sidewall according to the invention is similar to the control A1, while the composition A3 exhibits a much reduced performance. This raw breaking stress performance is particularly advantageous for the manufacture of internal layers and in particular semi-finished products.

### II-2-B. Example B

The compositions prepared comprise the same contents of all the ingredients, except for the elastomers. The control composition B1 does not comprise TPEI while, in the compositions B2 to B7 in accordance with the invention, the content of diene elastomer is lowered in order to add a portion of TPEI to the composition.

Airtightness tests and breaking stress measurement tests as described above were carried out on these compositions. All the compositions and also the airtightness and breaking stress performances in base 100 are presented in Table 2. The composition B1 is taken as reference and the contents are all expressed in phr.

TABLE 2

| Composition No.: | B1 | B2 | B3 | B4 | B5 | B6 | B7 |
|---|---|---|---|---|---|---|---|
| NR (1) | 35 | 33 | 28 | 24 | 21 | 17 | 14 |
| BR (2) | 65 | 62 | 52 | 46 | 39 | 33 | 26 |
| SIBS (3) | 0 | 5 | 20 | 30 | 40 | 50 | 60 |
| Carbon black (4) | 61 | 61 | 61 | 61 | 61 | 61 | 61 |
| Plasticizer (5) | 27 | 27 | 27 | 27 | 27 | 27 | 27 |
| Antioxidant (6) | 4 | 4 | 4 | 4 | 4 | 4 | 4 |
| Stearic acid | 1 | 1 | 1 | 1 | 1 | 1 | 1 |
| ZnO | 3 | 3 | 3 | 3 | 3 | 3 | 3 |
| Sulphur | 2 | 2 | 2 | 2 | 2 | 2 | 2 |
| Accelerator (7) | 1 | 1 | 1 | 1 | 1 | 1 | 1 |
| Relative airtightness | 100 | 105 | 128 | 140 | 148 | 167 | 167 |
| Cured breaking | 100 | 111 | 102 | 108 | 112 | 106 | 87 |
| stress performance | | | | | | | |

(1) NR Natural rubber
(2) BR with 0.5% of 1,2-units; 1.2% of trans units; 98.3% of cis-1,4-units (Tg = −106° C.)
(3) SIBS, Sibstar 102 T, sold by Kaneka
(4) ASTM grade N683, sold by Cabot
(5) MES oil, Catenex SNR, sold by Shell
(6) N-(1,3-Dimethylbutyl)-N′-phenyl-p-phenylenediamine, 6-PPD from Flexsys
(7) N-Cyclohexyl-2-benzothiazolesulphenamide, Santocure CBS from Flexsys

The results presented in Table 2 show a significant enhancement in the airtightness performance of the compositions B2 to B7 in accordance with the invention in comparison with the performance of the composition B1. In terms of cured breaking stress, the compositions B2 to B6 exhibit a slightly better performance than the control composition while, for the composition B7, it is apparent that the performance falls slightly while keeping a very acceptable level according to the tyre applications envisaged.

Thus and unexpectedly, the invention provides manufacturers with a solution making it possible to obtain tyre external sidewalls which exhibit an improved airtightness while retaining good breaking stress properties (indeed even an improved performance), in comparison with the external sidewalls used industrially.

1.-17. (canceled)

18. A tire comprising an external sidewall which includes at least one rubber composition including:
at least one diene elastomer at a total content of 1 to 99 phr,
at least one thermoplastic elastomer having a polyisobutylene block at a total content of 1 to 99 phr,
optionally a reinforcing filler at a content of 0 to 120 phr, and
a crosslinking system.

19. The tire according to claim 18, wherein the content of the at least one thermoplastic elastomer having a polyisobutylene block is from 1 to 80 phr.

20. The tire according to claim 19, wherein the content of the at least one thermoplastic elastomer having a polyisobutylene block is from 1 to 60 phr.

21. The tire according to claim 18, wherein the content of the at least one thermoplastic elastomer having a polyisobutylene block is from 5 to 60 phr.

22. The tire according to claim 21, wherein the content of the at least one thermoplastic elastomer having a polyisobutylene block is from 5 to 50 phr.

23. The tire according to claim 18, wherein the at least one thermoplastic elastomer having a polyisobutylene block comprises, at at least one of the ends of the polyisobutylene block, a thermoplastic block having a glass transition temperature greater than or equal to 60° C.

24. The tire according to claim 23, wherein the thermoplastic block of the at least one thermoplastic elastomer having a polyisobutylene block is composed of at least one polymerized monomer selected from the group consisting of: styrene, methylstyrenes, para(tert-butyl)styrene, chlorostyrenes, bromostyrenes, fluorostyrenes, para-hydroxystyrene, and mixtures thereof.

25. The tire according to claim 24, wherein the at least one thermoplastic elastomer having a polyisobutylene block is selected from the group consisting of: styrene/isobutylene diblock copolymers, styrene/isobutylene/styrene triblock copolymers, and mixtures thereof.

26. The tire according to claim 25, wherein the at least one thermoplastic elastomer having a polyisobutylene block is a styrene/isobutylene/styrene triblock copolymer.

27. The tire according to claim 23, wherein the thermoplastic block of the at least one thermoplastic elastomer having a polyisobutylene block is composed of at least one polymerized monomer selected from the group consisting of: ethylene, propylene, ethylene oxide, vinyl chloride, acenaphthylene, indene, 2-methylindene, 3-methylindene, 4-methylindene, dimethylindenes, 2-phenylindene, 3-phenylindene, 4-phenylindene, isoprene, esters of acrylic acid, crotonic acid, sorbic acid and methacrylic acid, acrylamide derivatives, methacrylamide derivatives, acrylonitrile derivatives, methacrylonitrile derivatives, methyl methacrylate, cellulose derivatives, and mixtures thereof.

28. The tire according to claim 18, wherein the at least one diene elastomer is selected from the group consisting of: essentially unsaturated diene elastomers and mixtures thereof.

29. The tire according to claim 28, wherein the at least one diene elastomer is selected from the group consisting of: homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof.

30. The tire according to claim 29, wherein the at least one diene elastomer is selected from the group consisting of: polybutadienes, synthetic polyisoprenes, natural rubber, butadiene copolymers, isoprene copolymers, and mixtures thereof.

31. The tire according to claim 18, wherein the content of reinforcing filler is from 0 to 90 phr.

32. The tire according to claim 31, wherein the content of reinforcing filler is from 5 to 80 phr.

33. The tire according to claim 18, wherein the content of reinforcing filler is from 0 to 70 phr.

34. The tire according to claim 33, wherein the content of reinforcing filler is from 5 to 70 phr.

35. The tire according to claim 18, wherein the reinforcing filler is carbon black, or silica, or a mixture of carbon black and silica.

36. The tire according to claim 35, wherein the reinforcing filler is predominantly carbon black.

37. The tire according to claim 18, wherein the content of the at least one diene elastomer is from 60 to 90 phr and the content of the at least one thermoplastic elastomer having a polyisobutylene block is from 10 to 40 phr.

38. The tire according to claim 18, wherein the rubber composition of the external sidewall does not comprise a polyisobutylene elastomer.

39. The tire according to claim 18, wherein the rubber composition of the external sidewall comprises less than 15 phr of a polyisobutylene elastomer.

40. The tire according to claim 39, wherein the rubber composition of the external sidewall comprises less than 10 phr of a polyisobutylene elastomer.

41. The tire according to claim 40, wherein the rubber composition of the external sidewall comprises less than 5 phr of a polyisobutylene elastomer.
